(19) United States
(12) Patent Application Publication
(10) Pub. No.: US 2021/0149387 A1
(43) Pub. Date: May 20, 2021

(54) FACILITY FAILURE PREDICTION SYSTEM AND METHOD FOR USING ACOUSTIC SIGNAL OF ULTRASONIC BAND

(71) Applicant: MOVIC LAB INC., Incheon (KR)

(72) Inventor: Won Keun LEE, Incheon (KR)

(73) Assignee: MOVIC LAB INC., Incheon (KR)

(21) Appl. No.: 17/003,562

(22) Filed: Aug. 26, 2020

Related U.S. Application Data
(63) Continuation of application No. PCT/KR2019/017803, filed on Dec. 16, 2019.

(30) Foreign Application Priority Data
Nov. 18, 2019 (KR) 10-2019-0147610

(51) Int. Cl. G05B 23/02; G01N 29/12

(52) U.S. Cl. CPC G05B 23/0283; G01N 29/12

(57) ABSTRACT

Disclosed are a facility failure prediction system and method using an acoustic signal of the ultrasonic band. The facility failure prediction system using an ultrasonic band according to the present disclosure includes a detection sensor located adjacent to a facility, and a server configured to determine whether sampling data extracted from an acoustic signal is a normal signal or an abnormal signal to generate a plurality of labeling information, to analyze sampling data corresponding to abnormal signal labeling information determined as an abnormal signal to generate abnormal signal analysis information, and to analyze a pattern of normal signal labeling information determined as the normal signal among the plurality of labeling information and the abnormal signal analysis information to provide failure prediction information for the facility.

### CROSS-REFERENCE TO RELATED APPLICATIONS

The present application is a continuation of International Patent Application No. PCT/KR2019/017803, filed on Dec. 16, 2019, which is based upon and claims the benefit of priority to Korean Patent Application No. 10-2019-0147610, filed on Nov. 18, 2019. The disclosures of the above-listed applications are hereby incorporated by reference herein in their entirety.

### TECHNICAL FIELD

The present disclosure relates to a facility failure prediction system and method using the ultrasonic band.

More specifically, the present disclosure relates to a facility failure prediction system and method for providing failure prediction information for a facility using signals of ultrasonic bands among acoustic signals generated at the facility.

### BACKGROUND ART

In general, a facility line of a facility which needs to be operated stably and continuously in an industrial site may be stopped due to sudden breakdown that causes fatal damage to the facility line itself and an unexpected failure to decrease in production, and thus, in order to prevent this, methods for predicting facility failure have been studied and developed.

The current failure prediction method includes a method of detecting a change in an abnormal state of a facility, detecting a defect occurring here, determining a state of the facility or a component, and predicting the life of the facility.

However, in the related art facility failure prediction system or method, in many cases, a sensor that senses a signal related to a defect in a facility is directly attached to the facility to measure a change in sound, vibration, heat, or current to detect a problem of the facility.

However, in the case of the sensor attached to the facility, continuous vibration of the facility acts as an element that interferes with sensor detection, causing problems in accurate failure prediction.

In addition, as a failure prediction system for detecting a problem in a plane by sensing a sound during operation of the facility, there is an existing case in which an abnormal sound of a facility is detected within an audible frequency. In this case, however, since an abnormal sound of the facility is detected only with the audible frequency, accuracy and perceived speed of failure prediction is lowered.

### DISCLOSURE

### Technical Problem

An aspect of the present disclosure is to provide a facility failure prediction system and method.

More specifically, the present disclosure provides a facility failure prediction system and method for providing failure prediction information for a facility using signals of ultrasonic bands among acoustic signals generated at the facility.

### Technical Solution

According to an aspect of the present disclosure, a facility failure prediction system includes: a detection sensor positioned adjacent to a facility and configured to collect an acoustic signal from sound generated when the facility operates; a sampling data extractor configured to sample the acoustic signal, to cancel noise, and to extract sampling data; a signal discriminator configured to determine whether the sampling data is a normal signal or an abnormal signal and to generate a plurality of labeling information; an abnormal signal analyzer configured to analyze the sampling data corresponding to abnormal signal labeling information determined as an abnormal signal among the plurality of labeling information and to generate abnormal signal analysis information; and a pattern analyzer configured to analyze a pattern of normal signal labeling information determined as the normal signal among the plurality of labeling information and the abnormal signal analysis information and to provide failure prediction information for the facility.

The facility failure prediction system may further include: a database (DB) unit including a sampling data DB configured to store the sampling data; and a detected signal information DB configured to store labeling information in which the sampling data is determined as a normal signal or an abnormal signal.

The signal discriminator, the abnormal signal analyzer, and the pattern analyzer may be provided in one server.

The sampling data input to the signal discriminator may be information subdivided based on a predetermined time.

The abnormal signal analysis information output from the abnormal signal analyzer may include values obtained by analyzing a kind and level of an abnormality type for sampling data corresponding to the abnormal signal labeling information.

The pattern analyzer may receive the normal signal labeling information from the detected signal information DB, receive the abnormal signal analysis information from the abnormal signal analyzer, and analyze a pattern of the information.

The pattern analyzer may analyze the pattern by arranging the normal signal labeling information and the abnormal signal analysis information in a time-series manner in a time-ordered sequence.

The detection sensor may be spaced apart from the facility.

The detection sensor may convert the collected acoustic signal into a digital signal, a sampling rate for converting the acoustic signal into the digital signal may be higher than 35 kHz, and the sampling rate may be 35 kHz to 300 kHz, for example.

Either the detection sensor or the server may filter an ultrasonic band signal from the collected acoustic signal.

Either the detection sensor or the server may extract the sampling data by canceling noise from the extracted ultrasonic band signal.

According to another aspect of the present disclosure, a facility failure prediction method includes: a sampling data extraction operation of sampling an acoustic signal generated in a facility and canceling noise to extract sampling data; a signal determination operation of determining whether the sampling data is a normal signal or an abnormal signal and generating and storing labeling information; an abnormal signal analysis operation of receiving and analyzing sampling data corresponding to abnormal signal labeling information determined as an abnormal signal among the labeling information and outputting abnormal signal analysis information; and a pattern analysis operation of analyzing a pattern of a facility failure from the normal signal labeling information determined as the normal signal among the plurality of labeling information and the abnormal signal analysis information.

In the signal determination operation, sampling data subdivided based on a predetermined time may be used.

The abnormal signal analysis information may include a value obtained by analyzing a kind and level of an abnormality type for sampling data corresponding to the abnormal signal labeling information.

In the pattern analysis operation, the pattern may be analyzed by arranging the normal signal labeling information and the abnormal signal analysis information in a time-series manner in a time-ordered sequence.

The facility failure method may further include: a sound wave collection operation of collecting an acoustic signal from sound generated when the facility operates before the signal determination operation; and an ultrasonic band filtering operation of filtering the collected acoustic signal to extract an ultrasonic band signal.

In the sound wave collection operation, the collected acoustic signal may be converted into a digital signal, and a sampling rate for converting the acoustic signal into the digital signal may be higher than 35 kHz.

### Advantageous Effects

According to the facility failure prediction system and method of an example of the present disclosure, failure prediction information for a facility is provided using an ultrasonic band signal among acoustic signals generated during the operation of the facility, so that a user may quickly handle the facility in a factory, and thus, a cost of damage due to shutdown of the facility may be minimized.

### DESCRIPTION OF DRAWINGS

FIG. 1 is a view illustrating an outline of a facility failure prediction system according to an embodiment of the present disclosure.

FIG. 2 is a view illustrating an example of a detection sensor 100 shown in FIG. 1.

FIG. 3 is a view illustrating an example of a server 200 shown in FIG. 1.

FIGS. 4 to 6 are views illustrating an example of a facility failure prediction method according to an embodiment of the present disclosure.

FIG. 7 is a view illustrating an example of failure prediction information provided by a facility failure prediction system according to an embodiment of the present disclosure.

### BEST MODE FOR INVENTION

Hereinafter, embodiments of the present disclosure will be described in detail with reference to the accompanying drawings. In describing the present invention, if it is determined that a detailed description of known functions and components associated with the present invention unnecessarily obscure the gist of the present invention, the detailed description thereof will be omitted. The terms used henceforth are used to appropriately express the embodiments of the present invention and may be altered according to a person of a related field or conventional practice. Therefore, the terms should be defined on the basis of the entire content of this specification.

Hereinafter, a facility failure prediction system and a facility failure prediction method according to the present disclosure will be described with reference to the accompanying drawings.

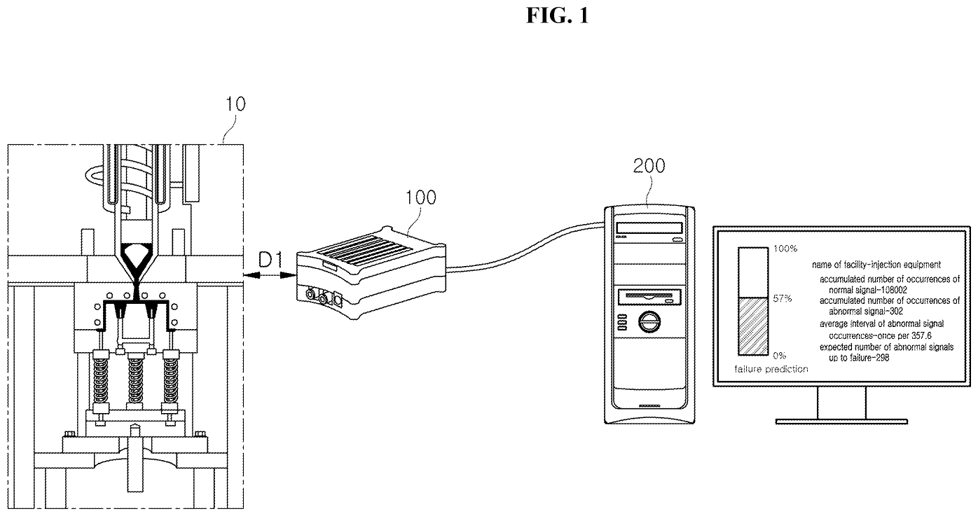

FIG. 1 is a view illustrating an outline of a facility failure prediction system according to an embodiment of the present disclosure.

A defect or damage that occurs in a facility 10 in the manufacturing site may cause a shutdown of the facility 10, and the amount of resultant economic damage is enormous, so it is recognized to be important to take action before a failure occurs to reduce cost.

Pant failure prediction is a technology for diagnosing a state of the facility 10 in real-time to detect an abnormal condition early and predict a failure that may occur in the future to take appropriate measures, thereby improving the stability of the facility 10.

In recent years, an industrial field to apply such facility failure prediction has also expanded, and facility failure prediction is expected to significantly contribute to production sales.

To this end, the facility failure prediction system according to an embodiment of the present disclosure may include a detection sensor 100 and a server 200 required for prediction of facility failure as illustrated in FIG. 1.

The detection sensor 100 may be located adjacent to the facility 10, maybe physically spaced from the facility 10, and may collect acoustic signals from sound generated when the facility 10 operates.

Since the detection sensor 100 according to an embodiment of the present disclosure collects ultrasonic acoustic signals, the detection sensor 100 does not need to be in direct contact with the facility 10 and any impact that may occur during the operation of the facility 10 is not transferred to the detection sensor 100, the durability of the detection sensor 100 may be relatively improved.

The acoustic signal may be signal-processed, sampled, and filtered into an ultrasonic band signal, and the noise of the ultrasonic band signal is canceled to obtain sampling data. The server 200 may determine whether the sampling data is a normal signal or an abnormal signal, analyze the sampling data for abnormal signal labeling information determined as an abnormal signal to generate abnormal signal analysis information, analyze a time-series pattern of the abnormal signal analysis information, and provides failure prediction information for the facility 10.

To this end, the server 200 (1) may generate a plurality of labeling information by determining whether the sampling data is a normal signal or an abnormal signal, (2) generate abnormal signal analysis information analyzed for the sampling data corresponding to abnormal signal labeling information determined as an abnormal signal among the plurality of labeling information, and (3) analyze a pattern of the normal signal labeling information determined as the normal signal among the plurality of labeling information and the abnormal signal analysis information, provide failure prediction information for the facility to an administrator so that the administrator may take measures in advance before the facility 10 is completely broken down.

Physical failure of the general mechanical facility 10 may accompany damage to a connected portion, as well as a faulty portion, and thus, the facility failure prediction system according to an embodiment of the present disclosure is expected to reduce repair costs through precautionary measures.

In addition, if a failure occurs in the facility 10, it takes a considerable time to repair the malfunctioned facility 10, and in this case, the facility failure prediction system of an embodiment of the present disclosure may prevent failure of the facility 10 through precautionary measures to eliminate a situation in which a rate of operation is lowered, thus obtaining an effect of improving productivity.

In addition, the facility failure prediction system according to an embodiment of the present disclosure is capable of proactive measures for abnormal conditions of the facility 10 through prediction of a facility failure, thereby preventing product quality deterioration, which is one of the prognostic symptoms of failure of the facility 10, and therefore, it may be expected to maintain and improve quality of the products being produced.

In such a facility failure prediction system, a high-sensitivity audio card measurable for an ultrasonic band may be included in the detection sensor 100 for fine detection.

In addition, for efficient data analysis, before analyzing the acoustic signal, sampling data from which the noise of a factory environment was canceled may be extracted, and machine learning may be applied to determine whether the extracted sampling data is a normal signal or an abnormal signal.

In addition, when it is determined that the sampling data is an abnormal signal, abnormal signal analysis information regarding a kind and level of an abnormality type of a facility that generates the abnormal signal may be provided more accurately and efficiently by applying deep learning algorithms by using sampling data which is row data for the corresponding abnormal signal.

In addition, failure prediction information regarding the facility may be provided by executing a pattern analysis program previously installed in the server using the normal signal labeling information determined as the normal signal among the plurality of labeling information and the abnormal signal analysis information.

Hereinafter, a configuration of the detection sensor 100 and the server 200 applied to an example of the present disclosure will be described in more detail.

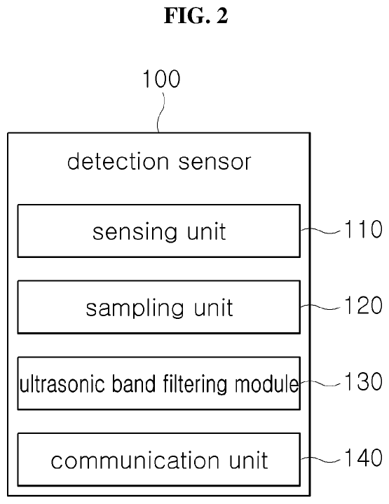

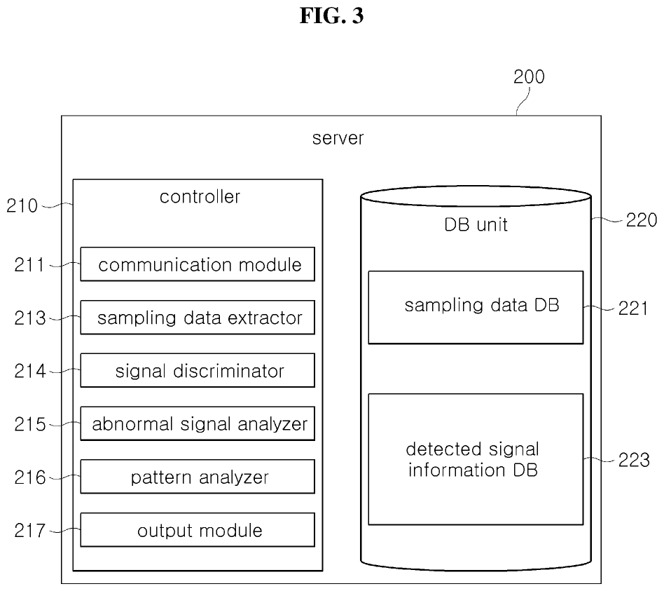

FIG. 2 is a view illustrating an example of the detection sensor 100 shown in FIG. 1, and FIG. 3 is a view illustrating an example of the server 200 shown in FIG. 1.

In FIGS. 2 and 3, a case where the detection sensor 100 includes an ultrasonic band filtering module 130, and the server 200 does not have the ultrasonic band filtering module 130 is illustrated as an example, but the present disclosure is not limited thereto, and unlike the case of FIGS. 2 and 3, the ultrasonic band filtering module 130 may be provided in the server 200 rather than in the detection sensor.

Hereinafter, for the purpose of description, as illustrated in FIGS. 2 and 3, the case where the detection sensor 100 includes the ultrasonic band filtering module 130 and the server 200 does not have an ultrasonic band filtering module 130 will be described as an example.

In addition, in FIGS. 2 and 3, a case where the server 200 includes a sampling data extractor 213 and the detection sensor 100 does not have the sampling data extractor 213 is illustrated as an example, but the present disclosure is not limited thereto, and unlike the case of FIGS. 2 and 3, the detection sensor 100 may include the sampling data extractor 213 and the server 200 may not have the sampling data extractor 213.

Hereinafter, for the purpose of description, as shown in FIGS. 2 and 3, the case where the server 200 includes the sampling data extractor 213 and the detection sensor 100 does not have the sampling data extractor 213 will be described as an example.

In addition, in FIG. 3, a case where a signal discriminator 214, an abnormal signal analyzer 215, and a pattern analyzer 216 are provided in one server is illustrated as an example, but the present disclosure is not limited thereto, and signal discriminator 214, the anomaly signal analyzer 215, and the pattern analyzer 216 may be spaced apart from each other and maybe provided in different servers.

The detection sensor 100 may include a sensing unit 110, a sampling unit 120, an ultrasonic band filtering module 130 and a communication unit 140 to collect acoustic signals from sound generated when the facility 10 operates.

The sensing unit 110, physically spaced apart from the facility 10, may collect acoustic signals from sound generated when the facility 10 operates. For example, the sensing unit 110 may have a MEMS microcircuit.

The sampling unit 120 may serve to convert an acoustic signal collected in the form of an analog signal from the sensing unit 110 into a digital signal. The sampling unit 120 may have a separate filter and an amplification circuit to enable high sensitivity measurement and analysis, and a sampling rate for converting the analog signal into the digital signal may be higher than 35 kHz.

For example, the sampling rate may be 35 kHz to 300 kHz, preferably 100 kHz to 300 kHz, and more preferably 190 kHz to 300 kHz.

The ultrasonic band filtering module 130 may filter and extract an ultrasonic band signal from the digital acoustic signal sampled with high sensitivity. That is, the ultrasonic band filtering module 130 may remove a signal having a band lower than an ultrasonic band from the acoustic signal and extract only an acoustic signal having an ultrasonic band.

The extracted acoustic signal having the ultrasonic band maybe 35 kHz or higher and may include an acoustic signal having a band of 35 kHz to 300 kHz band, for example.

The communication unit 140 may transmit the acoustic signal collected by the detection sensor 100 to the server 200 through wirelessly or by a wire. In FIG. 1, a case where the detection sensor 100 and the server are connected by a wire is illustrated, but the present disclosure is not limited thereto and the detection sensor 100 and the server 200 may interwork with each other via the Internet.

As shown in FIG. 3, the server 200 may include a controller 210 and a database (DB) unit 220.

The DB unit 220 may store the sampling data and perform signal determination on sampled data, so that labeling information, which is data information determined as a normal signal or an abnormal signal, may be stored.

To this end, the DB unit 220 may include a sampling data DB 221 storing sampling data having a row-data form for a target signal and a detected signal information DB 223 storing labeling information generated after the signal determination was performed on the sampling data.

Here, the sampling data stored in the DB unit 220 may have a row-data form for a predetermined time reference regarding the digital signal converted from an analog signal after the analog signal was sampled.

Each of the sampling data may be subdivided into a predetermined time reference and stored. For example, if the subdivided time reference is determined in units of 0.5 msec, the sampling data stored in the sampling data DB 221 may have a time length of 0.5 msec, and if the subdivided time reference is 1 second, the sampling data stored in the sampling data DB 221 may have a time length of 1 second.

As described above, the sampling data stored in the sampling data DB 221 may include information on a waveform of the corresponding signal and time information on the sampling data during a predetermined time reference.

As such, the time length of the sampling data stored in the sampling data DB 221 may be previously set in the server and may be changed by a server administrator for optimization.

The sampling data DB 221 may be used for training and testing of sampling data initially for signal determination and may be used throughout during the operation of the facility failure prediction system after an initial operation, and may be used to determine whether sampling data is abnormal.

The detected signal information DB 223 may store labeling information obtained by the signal determination on the sampling data stored in the sampling data DB 221.

Since the labeling information is signal labeling information determined for each of a plurality of sampling data stored in the sampling data DB 221, each labeling information may include labeling information regarding whether corresponding sampling data is a normal signal or an abnormal signal and identification information or time information for sampling data itself.

For example, if the sampling data is determined as a normal signal, normal signal labeling information determined as a normal signal for the corresponding sampling data may be stored, and if the sampling data is determined as an abnormal signal, abnormal signal labeling information determined as an abnormal signal for the corresponding sampling data may be stored.

Accordingly, the sum of the number of normal signal labeling information and the number of abnormal signal labeling information stored in the detected signal information DB 223 may be equal to the sum of a total number of sampling data stored in the sampling data DB 221, and the normal signal labeling information and the abnormal signal labeling information may match the sampling data, respectively.

Therefore, if the server selects any one abnormal signal labeling information from the detected signal information DB 223, sampling data having a raw data form for the corresponding abnormal signal labeling information may also be selected from the sampling data DB 221.

The controller 210 may extract sampling data, which has an ultrasonic band, from the acoustic signal, determine whether signal-processed data is a normal signal or an abnormal signal, perform abnormal signal analysis on sampling data determined as an abnormal signal, generate abnormal signal analysis information for the corresponding sampling data, arrange normal signal sampling information and the abnormal signal analysis in a time-series manner, analyze time-series patterns of the normal signal sampling information and the abnormal signal analysis information, and provide prediction information regarding the failure of the facility.

To this end, the controller 210 may include a communication module 211, a sampling data extractor 213, an abnormal signal discriminator 214, an abnormal signal analyzer 215, a pattern analyzer 216, and an output module 217.

The communication module 211 may be connected to the detection sensor 100 by wire or wirelessly and receive an acoustic signal having an ultrasonic band transmitted from the detection sensor 100. As described above, the acoustic signal input to the communication module of the server may be, for example, data information on a signal which has been sampled and filtered to an ultrasonic band.

The sampling data extractor 213 may extract sampling data by canceling noise from the ultrasonic band signal input through the communication module. Specifically, the acoustic signal coming from a factory environment where the facility 10 is located may be an acoustic signal with unnecessary noise information such as the mechanical sound of other machines or parts and human noise of the facility 10 synthesized therein.

The sampling data extractor 213 may filter and cancel noise from the acoustic signal to thereby extract sampling data from the acoustic signal generated by a specific part of the facility 10, and use the extracted sampling data in data analysis to thereby increasing the accuracy of the analysis.

As described above, the controller may sample the acoustic signal measured in the facility, perform ultrasonic band filtering, and determine and analyze sampling data in the form of row data without noise, analyze a pattern in a time-series manner, and provide prediction information regarding the facility to the user or the administrator.

In order to perform these operations, the controller may include the signal discriminator 214, the abnormal signal analyzer 215, and the pattern analyzer 216 as described above.

The signal discriminator 214 may determine whether each of the sampling data stored in the sampling data DB 221 is a normal signal or an abnormal signal and generate labeling information for each of the determined sampling data.

Here, as for the labeling information, for example, if certain sampling data is determined as a normal signal, normal signal labeling information Sn may be generated for the corresponding sampling data. In addition, if certain sampling data is determined as an abnormal signal, abnormal signal labeling information Sa may be generated for the corresponding sampling data.

As described above, the normal signal labeling information and abnormal signal labeling information determined by the signal discriminator 214 for a plurality of sampling data may be updated and stored in the detected signal information DB 223.

As an example, the signal discriminator 214 may apply the K-mean algorithm of unsupervised learning among machine learning techniques to determine whether a plurality of sampling data is a normal signal or an abnormal signal for. However, the present disclosure is not limited to the application of machine learning described above.

In order to further improve the accuracy of determination of the machine learning technology for the sampling data, in the actual application of the machine learning technology, training and testing may be performed to repeatedly determine whether each of the sampling data stored in the sampling data DB 221 is a normal signal or an abnormal signal.

As described above, the signal discriminator 214 may determine whether each of the sampling data stored in the sampling data DB 221 is an abnormal signal, generate labeling information, and store the generated labeling information in the detected signal information DB 223.

The abnormal signal analyzer 215 may analyze a kind and level of an abnormality type for the sampling data corresponding to the abnormal signal labeling information determined as the abnormal signal by the signal discriminator 214 and generate abnormal signal analysis information.

Accordingly, the abnormal signal analysis information generated by the abnormal signal analyzer 215 may include values obtained by analyzing a kind and level of the abnormality type for the corresponding sampling data.

As described above, when the anomaly signal analyzer 215 analyzes sampling data, deep learning algorithms may be applied.

The pattern analyzer 216 may arrange the normal signal labeling information among information determined by the signal discriminator 214 and stored in the DB unit 220 and the abnormal signal analysis information for sampling data of the abnormal signal labeling information analyzed by the abnormal signal analyzer 215 in a time series manner and perform pattern analysis thereon.

When the pattern analyzer 216 performs pattern analysis, a pre-installed pattern analysis program may be used. For example, among hidden Markov model (HMM) and a deep learning model, a recurrent neural network specified for time series data analysis may be used as a learning model and at least one of long-short term memories (LSTM) may be applied for data pattern learning in various cases by utilizing information of long-term or short-term data. However, the present disclosure is not limited thereto.

As described above, the pattern analyzer 216 analyzes the pattern information using the normal signal labeling information and the abnormal signal analysis information, whereby a level of facility failure may be determined and a cause of the facility failure may be determined.

The output module 217 may provide failure prediction information for the facility 10 using the level and cause of the facility failure analyzed by the pattern analyzer 216.

Hereinafter, an example of a method for operating a facility failure prediction system will be described.

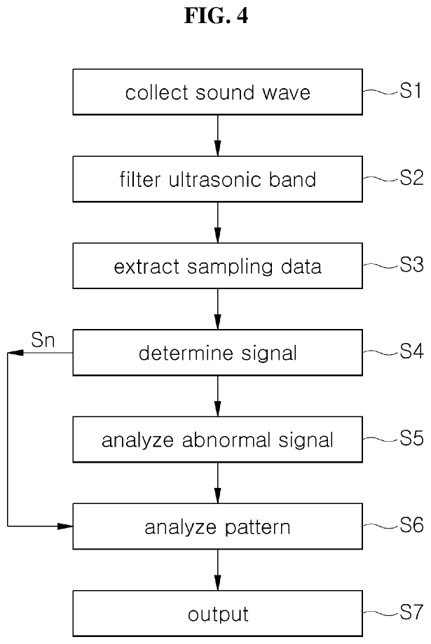

FIGS. 4 to 6 are views illustrating an example of a facility failure prediction system according to an embodiment of the present disclosure.

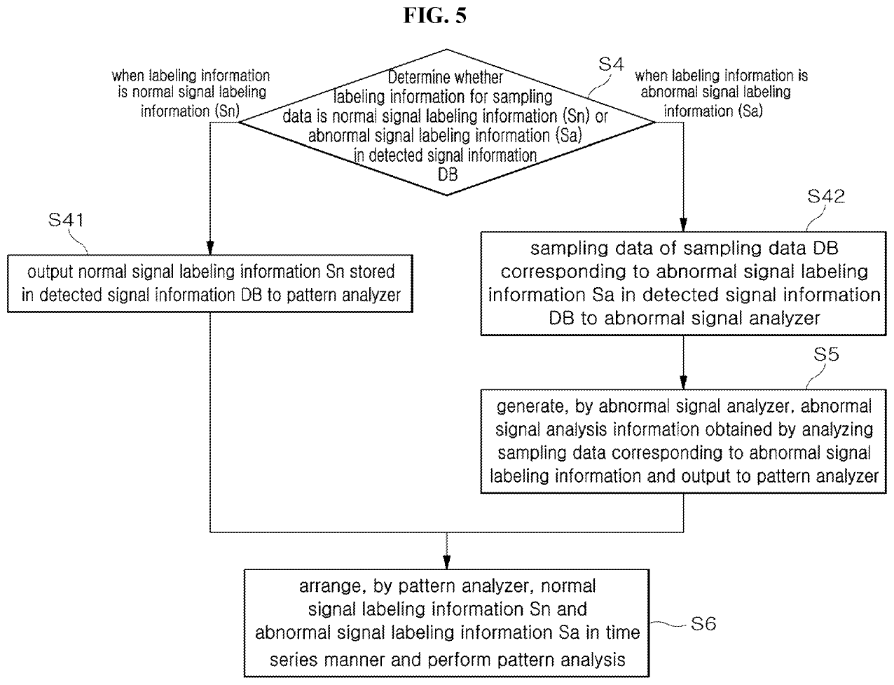

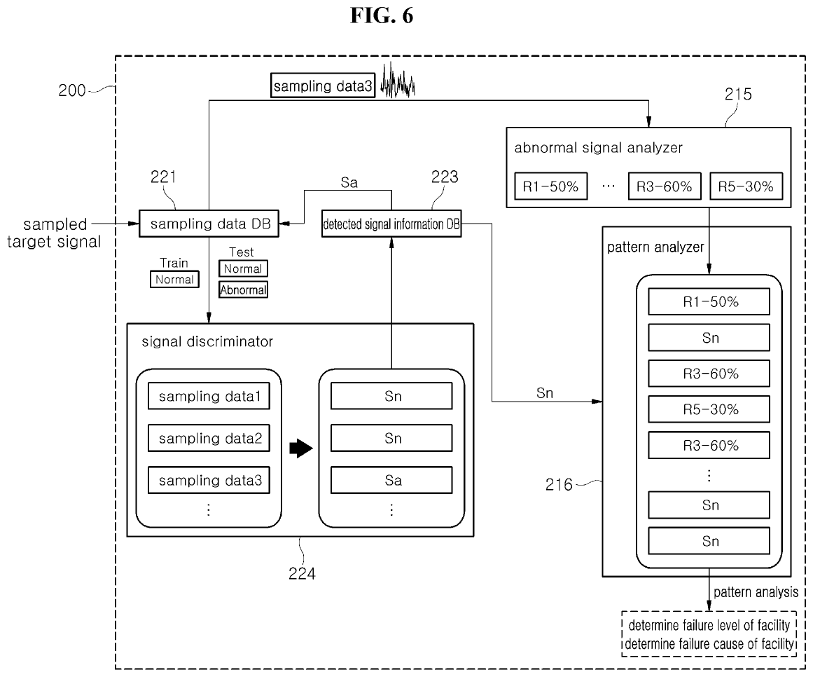

Specifically, FIG. 4 is a flowchart illustrating a process of a facility failure prediction method according to an embodiment of the present disclosure, FIG. 5 is a view specifically illustrating a signal determination step S4, an abnormal signal analysis step S5, and a pattern analysis step S6 illustrated in FIG. 4, and FIG. 6 is a view illustrating a signal flow when a facility failure prediction method is performed on a facility failure prediction system according to an embodiment of the present disclosure.

As illustrated in FIG. 4, the facility failure prediction method according to an embodiment of the present disclosure may include a sound wave collection step S1, an ultrasonic band filtering step S2, a sampling data extraction step S3, a signal determination step S4, an abnormal signal analysis step S5, a pattern analysis step S6, and an output step S7.

In the sound wave collection step S1, the detection sensor 100 may collect acoustic signals from sound generated when the facility 10 operates. Here, the collected acoustic signal may be analog and may be converted into a digital signal.

In the sound wave collection step S1, when the collected acoustic signal is converted into a digital signal, a sampling rate for converting the acoustic signal into a digital signal may be 35 kHz to 300 kHz, preferably 100 kHz to 300 kHz, and, more preferably 190 kHz to 300 kHz. In the ultrasound band filtering step S2, an ultrasound band is filtered from the acoustic signal which has been converted into a digital signal, so that an acoustic signal of the ultrasound band may be extracted.

In the sampling data extraction step S3, sampling data may be extracted by canceling noise from the extracted ultrasonic band signal.

As an example, in the noise filtering method, noise signal information for environment noise or background noise may be obtained in advance before the acoustic signal is collected and applied as a noise filter for the corresponding acoustic signal. However, the noise filtering method of the present disclosure is not limited thereto and any other method may also be performed.

The sampling data extracted in the sampling data extraction step may be data subdivided based on a predetermined time.

As described above, the sampling data subdivided based on the predetermined time may be stored in the sampling data DB 221 as shown in FIG. 6. As described above, the sampling data stored in the sampling data DB 221 may include information on a waveform of the corresponding signal and information on a generation time of the sampling data.

In the signal extraction step S4, the signal discriminator 214 may receive the sampling data from the sampling data DB 221, generate labeling information by determining whether the sampling data is a normal signal or an abnormal signal, and store the generated labeling information in the detected signal information DB 223.

Here, the signal discriminator 214 may determine whether the plurality of sampling signals are normal signals or abnormal signals by applying, for example, a K-mean algorithm of unsupervised learning among machine learning techniques. However, the present disclosure is not limited to the application of machine learning described above.

The labeling information stored in the detected signal information DB 223 may include labeling information on whether the sampling data is a normal signal or an abnormal signal and identification information or time information on the sampling data itself.

In addition, the labeling information may include normal signal labeling information Sn indicating that the sampling data is a normal signal and abnormal signal labeling information Sa indicating that the sampling data is an abnormal signal.

As an example, in the signal determination step S4, as illustrated in FIG. 6, it is determined whether the plurality of sampling data stored in the sampling data DB 221 is a normal signal or an abnormal signal to generate, for example, labeling information determined such that sampling data 1 is normal signal labeling information Sn, sampling data 2 is normal signal labeling information Sn, and sampling data 3 is abnormal signal labeling information Sa. Although not shown, each labeling information may include identification information for corresponding sampling data itself.

In the signal determination step S4, as shown in FIGS. 5 and 6, as for the labeling information stored in the detected signal information DB 223, whether the labeling information for the sampling data is the normal signal labeling information Sn or the abnormal signal labeling information Sa is determined, and if the labeling information is the normal signal labeling information Sn (S41 in FIG. 5), the controller 210 may output the normal signal labeling information Sn stored in the detected signal information DB 223 to the pattern analyzer 216.

In addition, when the labeling information is the abnormal signal labeling information Sa (S42 in FIG. 5), the controller 210 may output sampling data of the sampling data DB 221 corresponding to the abnormal signal labeling information Sa stored in the detected signal information DB 223 to the abnormal signal analyzer 215.

That is, as shown in FIG. 6, when the labeling information is the abnormal signal labeling information Sa, the controller 210 may output the corresponding sampling data of the abnormal signal labeling information Sa to the abnormal signal analyzer 215, so that the abnormal signal analysis step S5 may be performed to more closely analyze the corresponding sampling data.

In the abnormal signal analysis step S5, the sampling data corresponding to the abnormal signal labeling information Sa among the labeling information may be received and analyze to generate abnormal signal analysis information.

For example, as shown in FIG. 6, in the signal determination step S4, when the sampling data 3 is determined as an abnormal signal, the sampling data 3 corresponding to the abnormal signal labeling information Sa may be output from the sampling data DB 221 and input to the abnormal signal analyzer 215.

Here, the sampling data 3 may have a row-data form during a predetermined time reference, and the abnormal signal analyzer 215 may analyze the raw data included in the sampling data 3.

The abnormal signal analyzer 215 may apply a deep learning algorithm (Deep Learning Algorithms) to analyze the sampling data determined as an abnormal signal.

As described above, the abnormal signal analysis information generated by analyzing the sampling data in the abnormal signal analyzer 215 may include values obtained by analyzing a kind and level of the abnormality type for the sampling data corresponding to the abnormal signal labeling information Sa.

For example, the abnormal signal analyzer 215 may generate abnormal signal analysis information such as R1-50%, R3-60%, and R5-30% as the abnormal signal analysis information. The abnormal signal analyzer 215 may generate a kind and level of one or more abnormality types for one sampling data.

For example, regarding sampling data 3, an abnormality type kind 1 and R1-50% indicating a level of 50% may be generated as abnormal signal analysis information. Accordingly, R1-50%, R3-60%, and R5-30% may refer to abnormal signal analysis information analyzed for each of the three sampling data.

Here, R1, R3, and R5 may refer to kinds of abnormality types. That is, R1, R3, and R5 may refer to types that generate the corresponding sampling data determined as an abnormal signal. Such abnormality types may be one of several causes of facility failure.

In addition, the percentage linked to each of R1-50%, R3-60%, and R5-30% may refer to a level or magnitude of the abnormality type.

Accordingly, R3-60% may mean that it corresponds to abnormality type 3 and a level thereof is 60%, and R5-30% may mean that it corresponds to abnormality type 5 and a level 30%.

As described above, the abnormality type analyzed by the abnormal signal analyzer 215 may be set to be different for each facility and may be changed by the administrator or the user.

As described above, the abnormal signal analysis information analyzed by the abnormal signal analyzer 215 in the abnormal signal analysis step S5 may be output to the pattern analyzer 216, and thereafter, the pattern analysis step S6 may be performed.

In the pattern analysis step S6, the pattern analyzer 216 may receive normal signal labeling information Sn determined as a normal signal from among a plurality of labeling information from the detected signal information DB 223 and receive the abnormal signal analysis information from the abnormal signal analyzer 215, and analyze a pattern of facility failure.

To this end, the pattern analyzer 216 may arrange the normal signal labeling information Sn and the abnormal signal analysis information in a time-series manner in a time-ordered sequence.

For example, a plurality of normal signal labeling information Sn and abnormal signal analysis information (R1-50%, R3-60%, R5-30%, and R3-60%) may be arranged in a time-series manner in order of R1-50%, Sn, R3-60%, R5-30%, R3-60%, . . . , Sn, Sn, and the arranged pattern may be analyzed by the pattern analyzer 216.

As described above, the pattern arranged in the time series manner may be information obtained by analyzing characteristics of the signals for the respective sampling data input in chronological order.

The pattern analyzer 216 may analyze the time-series pattern of the normal signal labeling information Sn and the abnormal signal analysis information to determine a level of facility failure and a cause of the facility failure.

When the pattern analyzer 216 analyzes the time series pattern, among hidden Markov model (HMM) and a deep learning model, a recurrent neural network specified for time series data analysis may be used as a learning model and at least one of long-short term memories (LSTM) may be applied for data pattern learning in various cases by utilizing information of long-term or short-term data. However, the present disclosure is not limited thereto.

In the output step S7, the failure level of the facility and the cause of the facility failure analyzed by the pattern analyzer 216 may be output as failure prediction information of the facility.

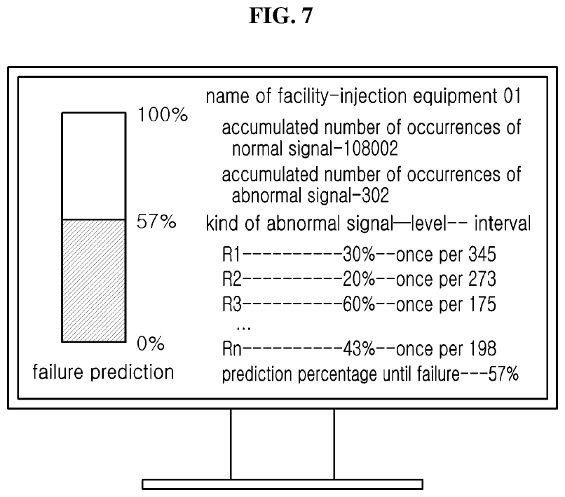

FIG. 7 is a view illustrating an example of failure prediction information provided by a facility failure prediction system according to an embodiment of the present disclosure.

The facility failure prediction system according to an embodiment of the present disclosure may provide failure prediction information as illustrated in FIG. 7.

Specifically, the failure prediction information may include at least a current state of the facility 10 and prediction information until failure of the facility 10 occurs.

As an example, as shown in FIG. 7, as the failure prediction information, a name of the facility 10, prediction information indicating a probability of failure until it occurs in percent, the number of occurrences of a normal signal, the number of occurrences of an abnormal signal, a level of each kind of an abnormality type, an occurrence interval, a predicted percentage up to the failure of the facility 10 may be displayed.

The facility failure prediction system and method according to an embodiment of the present disclosure provide failure prediction information on the facility 10 using an ultrasonic band signal in an acoustic signal generated during the operation of the facility 10, so that the user may be guided to promptly respond to the facility 10 in the factory, thereby minimizing a cost of damage caused by the shutdown of the factory.

The present disclosure is not limited to the above-described embodiments and the accompanying drawings, and various modifications and variations may be made from the viewpoint of a person having ordinary skills in the art to which the present disclosure pertains. Therefore, the scope of the present disclosure should be defined not only by the claims of the present specification, but also by the claims and equivalents thereof.

What is claimed is:

1. A facility failure prediction system comprising:
a detection sensor positioned adjacent to a facility and configured to collect an acoustic signal from sound generated when the facility operates;
a sampling data extractor configured to sample the acoustic signal, to cancel noise, and to extract sampling data;
a signal discriminator configured to determine whether the sampling data is a normal signal or an abnormal signal and to generate a plurality of labeling information;
an abnormal signal analyzer configured to analyze the sampling data corresponding to abnormal signal labeling information determined as an abnormal signal among the plurality of labeling information and to generate abnormal signal analysis information; and
a pattern analyzer configured to analyze a pattern of normal signal labeling information determined as the normal signal among the plurality of labeling information and the abnormal signal analysis information and to provide failure prediction information for the facility.

2. The facility failure prediction system of claim 1, further comprising:
a database (DB) unit including a sampling data DB configured to store the sampling data; and
a detected signal information DB configured to store labeling information in which the sampling data is determined as a normal signal or an abnormal signal.

3. The facility failure prediction system of claim 2, wherein
the signal discriminator, the abnormal signal analyzer, and the pattern analyzer are provided in one server.

4. The facility failure prediction system of claim 3, wherein
the sampling data input to the signal discriminator is information subdivided based on a predetermined time.

5. The facility failure prediction system of claim 3, wherein
the abnormal signal analysis information output from the abnormal signal analyzer comprises values obtained by analyzing a kind and level of an abnormality type for sampling data corresponding to the abnormal signal labeling information.

6. The facility failure prediction system of claim 3, wherein
the pattern analyzer receives the normal signal labeling information from the detected signal information DB, receives the abnormal signal analysis information from the abnormal signal analyzer, and analyzes a pattern of the information.

7. The facility failure prediction system of claim 3, wherein
the pattern analyzer analyzes the pattern by arranging the normal signal labeling information and the abnormal signal analysis information in a time-series manner in a time-ordered sequence.

8. The facility failure prediction system of claim 1, wherein
the detection sensor is spaced apart from the facility.

9. The facility failure prediction system of claim 1, wherein
the detection sensor converts the collected acoustic signal into a digital signal, and a sampling rate for converting the acoustic signal into the digital signal is higher than 35 kHz.

10. The facility failure prediction system of claim 9, wherein
the sampling rate is 35 kHz to 300 kHz.

11. The facility failure prediction system of claim 3, wherein
either the detection sensor or the server filters an ultrasonic band signal from the collected acoustic signal.

12. The facility failure prediction system of claim 11, wherein
either the detection sensor or the server extracts the sampling data by canceling noise from the extracted ultrasonic band signal.

13. A facility failure prediction method comprising:
a sampling data extraction operation of sampling an acoustic signal generated in a facility and canceling noise to extract sampling data;
a signal determination operation of determining whether the sampling data is a normal signal or an abnormal signal and generating and storing labeling information;
an abnormal signal analysis operation of receiving and analyzing sampling data corresponding to abnormal signal labeling information determined as an abnormal signal among the labeling information and outputting abnormal signal analysis information; and
a pattern analysis operation of analyzing a pattern of a facility failure from the normal signal labeling information determined as the normal signal among the plurality of labeling information and the abnormal signal analysis information.

14. The facility failure prediction method of claim 13, wherein,
in the signal determination operation, sampling data subdivided based on a predetermined time is used.

15. The facility failure prediction method of claim 13, wherein
the abnormal signal analysis information comprises values obtained by analyzing a kind and level of an abnormality type for sampling data corresponding to the abnormal signal labeling information.

16. The facility failure prediction method of claim 13, wherein,
in the pattern analysis operation, the pattern is analyzed by arranging the normal signal labeling information and the abnormal signal analysis information in a time-series manner in time-ordered sequence.

17. The facility failure prediction method of claim 13, further comprising:
a sound wave collection operation of collecting an acoustic signal from sound generated when the facility operates, before the signal determination operation;
converting the acoustic signal into a digital signal; and
an ultrasonic band filtering operation of filtering the collected acoustic signal to extract an ultrasonic band signal.

18. The facility failure prediction method of claim 17, wherein,
in converting the acoustic signal into the digital signal, a sampling rate for converting the acoustic signal into the digital signal is higher than 35 kHz.
